(19) United States
(12) Patent Application Publication
(10) Pub. No.: US 2024/0301859 A1
(43) Pub. Date: Sep. 12, 2024

(54) APPORTIONED SEGMENTS FOR A DUCTED TURBINE

(71) Applicant: Vincent Loccisano, Wellesley, MA (US)

(72) Inventor: Vincent Loccisano, Wellesley, MA (US)

(21) Appl. No.: 18/596,896

(22) Filed: Mar. 6, 2024

Related U.S. Application Data
(60) Provisional application No. 63/488,583, filed on Mar. 6, 2023.

(51) Int. Cl. F01D 17/12; F01D 9/04

(52) U.S. Cl. CPC F03D 1/053; F01D 9/04; F01D 17/12; F03D 1/042; F03D 1/051; F05B 2220/30; F05B 2240/12; F05B 2240/14

(57) ABSTRACT

Apportioned segments from the surface of a duct in a ducted turbine may be articulated to reduce the surface area of the duct. The apportioned segments are employed to reduce the surface area and therefore the wind resistance of the duct, in excessive wind conditions where excessive side loads are exerted upon the ducted turbine.

### TECHNICAL FIELD

The present disclosure relates, in general, to fluid turbines and more specifically to shrouded or ducted fluid turbines and control mechanisms thereof.

### BACKGROUND

Conventional horizontal-axis fluid turbines used for power generation have two to five open blades arranged like a propeller, with the blades mounted to a horizontal shaft attached to a gear box that drives a power generator. Excessive fluid-velocity events can cause various types of asymmetrical loading on the tower and rotor plane. Asymmetrical loading can cause oscillations that can effect electrical generation equipment and cause stress on the tower. Horizontal-axis turbine blades use pitch control for furling the blades into the wind to mitigate speed and torque on the generator, or to stow the blades in high fluid-velocity conditions. “Yawing” or rotating the turbine on the yaw-pivot, in a direction perpendicular to that of the wind, is one means of reducing fluid force on the rotor. In excessive fluid-velocity conditions, some turbines yaw out of the wind in this manner.

One skilled in the art understands that a properly designed duct delivers greater mass-flow rate through the duct than to a similar, open rotor. Improved performance over that of a similar open rotor, from a rotor in fluid communication with a properly designed duct, may be achieved due to a reduction of rotor-tip vortices and the increased unit mass flow through the duct.

The aerodynamic principles of a ducted turbine are not restricted to air and apply to any fluid in any form: liquid, gas or combination thereof. For convenience, we describe this invention in the context of ducted wind turbines.

### SUMMARY

The present invention controls and/or mitigates the forces exerted on the support structure of a ducted turbine in high-wind conditions. These forces can be caused by excessive wind in any direction, but usually by winds flowing perpendicular to the turbine's central axis. It is understood in the art that rotating a ducted turbine approximately 90 degrees away from the wind's direction protects the turbine in excessive fluid-velocity conditions. In this embodiment, the turbine's duct has apportioned duct segments that open to reduce the surface area of the duct when in that position.

In and example embodiment, a turbine has an annular duct, referred to as a turbine shroud, that is in fluid communication with a rotor. The turbine shroud has apportioned segments on its substantially vertical sections; these sections are referred to as side walls. The apportioned segments are hinged such that they may be rotated inward toward the central axis, or outward, away from the central axis. By rotating one apportioned segment inward and the corresponding segment outward, an opening is created in the side wall of the turbine shroud to allow wind to pass through rather than blow against the side wall. This alleviates force on the turbine and support structure.

References to “support structure” or “tower” herein are intended to include all structures used in orientating and supporting a turbine assembly. In an embodiment, turbine-support-structure or tower stress may be controlled by measuring tower base-moment or indicators thereof, including tower-top acceleration, tower tilt or rotor-power output; and responding by rotating the turbine out of the wind direction and opening apportioned segments to reduce wind forces on the turbine and support structure.

Individual apportioned segments can also apply a yaw moment to yaw the turbine upwind or downwind, as well as to mitigate rotation of the turbine on the vertical axis.

Another embodiment comprises a turbine shroud with an ejector shroud. The leading edge of the turbine shroud is substantially cylindrical, with a leading-edge airfoil cross section. In some embodiments the trailing edge of the turbine shroud is in fluid communication with a ringed airfoil, referred to as an ejector shroud. The turbine and ejector shroud are generally co-axial, or in other words, share a central axis that resides along the center of the cylindrical-airfoil shapes. Both turbine shroud and ejector shroud may comprise apportioned segments that pivot about an axis that is tangent with the airfoil ring and perpendicular to the central axis. These apportioned segments provide a means of mitigating the forces caused by excessive wind flowing perpendicular to the central axis of the turbine.

These and other non-limiting features or characteristics of the present disclosure will be further described below.

### BRIEF DESCRIPTION OF THE DRAWINGS

The following is a brief description of the drawings, which are presented for the purposes of illustrating the disclosure set forth herein and not for the purposes of limiting the same.

FIG. 1 is a front right perspective view of an exemplary embodiment of a shrouded fluid turbine.

FIG. 2 is a front right perspective view of the embodiment of FIG. 1.

FIG. 3 is a rear perspective view of the embodiment of FIG. 1.

FIG. 4 is a side orthographic view of the fluid turbine of FIG. 1.

FIG. 5 is a top cross-section view of the fluid turbine of FIG. 1.

FIG. 6 is a top cross-section view of the fluid turbine of FIG. 1.

FIG. 7 is a front right perspective view of an iteration of the exemplary embodiment.

FIG. 8 is a rear perspective view of the embodiment of FIG. 7.

FIG. 9 is a side orthographic view of the fluid turbine of FIG. 7.

FIG. 10 is a front right perspective view of the embodiment of FIG. 7 illustrating an example configuration of the embodiment.

FIG. 11 is a rear perspective view of the embodiment of FIG. 7 illustrating an example configuration of the embodiment.

FIG. 12 is a side orthographic view of the embodiment of FIG. 7 illustrating an example configuration of the embodiment.

### DETAILED DESCRIPTION

In this disclosure, “apportioned shroud segments” or “apportioned segments” are described as having a pivot point from which the apportioned segment surface rotates. The recitation of a pivot point, and associated pivoting apportioned segment, is for convenience and clarity and is not intended to be limiting in the present invention. The method, system and apparatus of the present invention may be practiced using a variety of suitable means.

A properly designed, ducted rotor delivers greater mass-flow rate to the rotor plane than to that of a similar, open rotor. Improved performance over that of a similar open rotor, from a rotor in fluid communication with a properly designed duct, may be achieved due to a reduction of rotor-tip vortices and the increased unit mass-flow through the duct.

A shrouded turbine with tandem, cambered shrouds enables improved power generation from fluid currents. The shrouded turbine includes tandem cambered shrouds. The primary shroud contains a rotor, which extracts power from a primary fluid stream. The tandem cambered shrouds and ejector bring more flow through the rotor allowing more energy extraction due to higher flow rates. The shrouds transfer energy from the bypass flow to the rotor-wake flow, enabling higher energy per unit mass-flow rate through the rotor. The effect enhances the overall power production of the wind turbine system.

In this disclosure, any type of rotor may be enclosed in the turbine shroud. The term “rotor” refers to any assembly in which one or more blades are attached to a shaft and able to rotate to extract power or energy from wind rotating the blades. Exemplary rotors include a propeller-like rotor or a rotor/stator assembly.

The leading edge of a turbine shroud may be considered the front of the fluid turbine, and the trailing edge of an ejector shroud may be considered the rear of the fluid turbine. A first component of the fluid turbine located closer to the front of the turbine may be considered “upstream” of a second, “downstream” component that is proximal to the rear of the turbine.

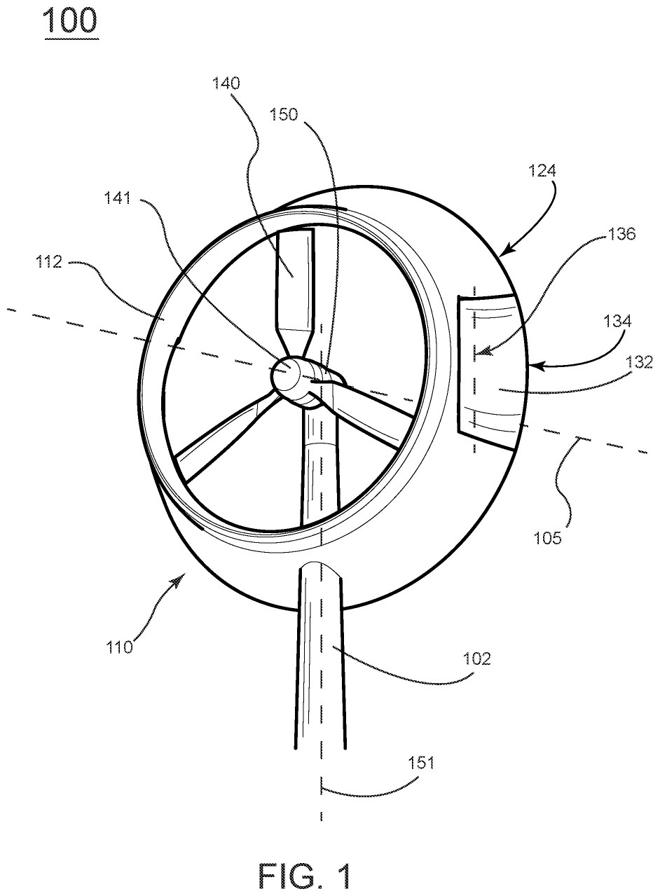

FIG. 1 shows a shrouded fluid turbine 100 comprising a turbine shroud 110, a nacelle body 150 and a rotor 140. The turbine shroud 110 includes a front or inlet end 112 (also referred to as a leading edge) and a rear or exhaust end 124 (also referred to as a trailing edge). The rotor 140, nacelle 150, and shroud 110 share a common axis 105. Apportioned segment 132 is derived from at least one portion of the ringed airfoil and may be articulated on a pivot axis 136. The apportioned segment 132, when in a closed position, has a trailing edge 134 that aligns with the turbine shroud's trailing edge 124.

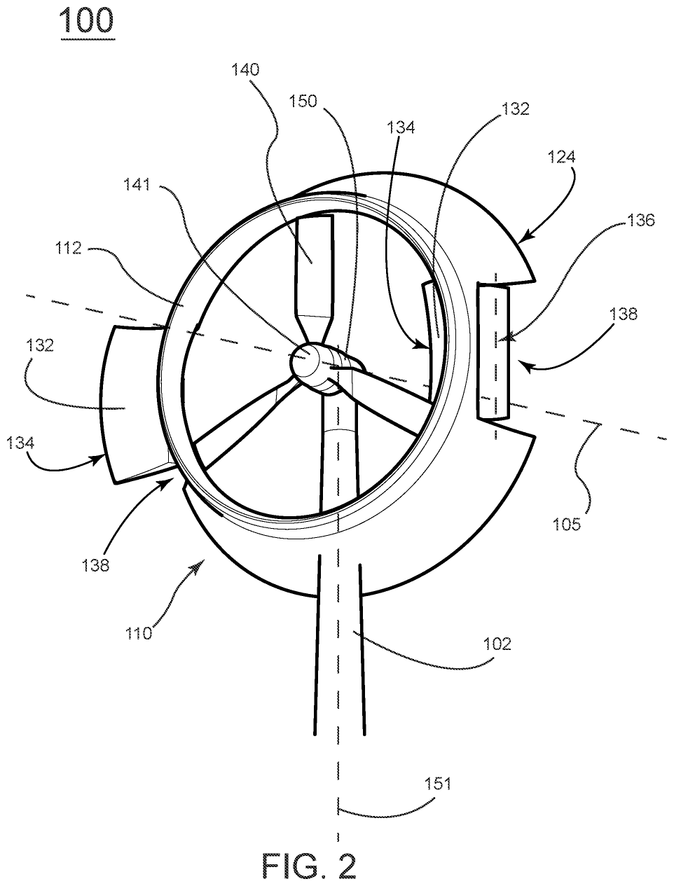

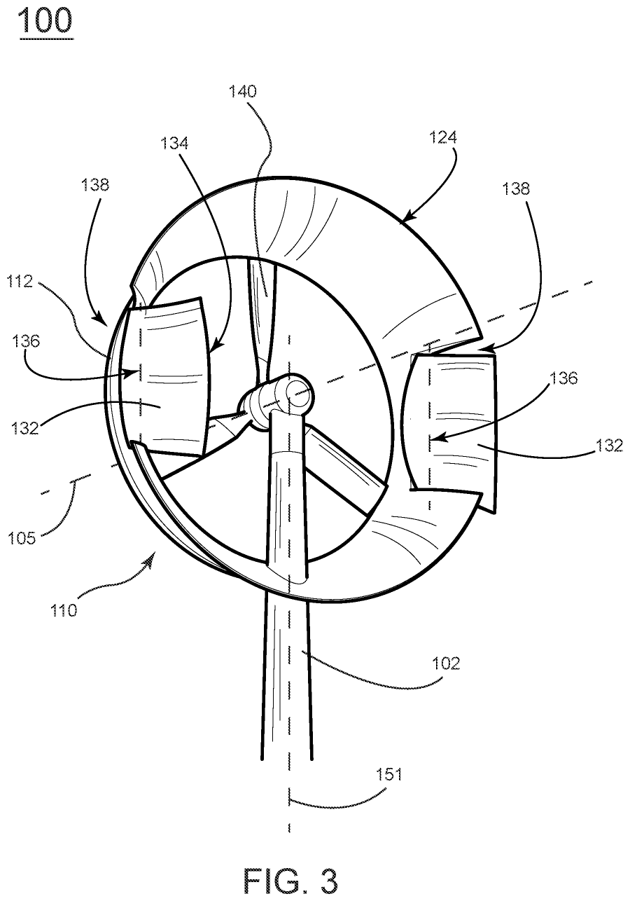

FIG. 2 through FIG. 4 illustrate the shrouded turbine 100 with apportioned segments 132 in an example configuration, in which a failsafe mitigates rotational forces in high winds when the turbine is stored with the central axis 105 perpendicular to the wind direction. Here one of the apportioned segments 132 is rotated inward about pivot axis 136, toward the central axis 105. An apportioned segment on the opposite side of the turbine is rotated outward, away from the central axis 105. An opening 138 is formed in the sidewall of the shroud 110. Wind flowing toward the side of the shrouded turbine 100 impacts the sidewall of the turbine as an impediment.

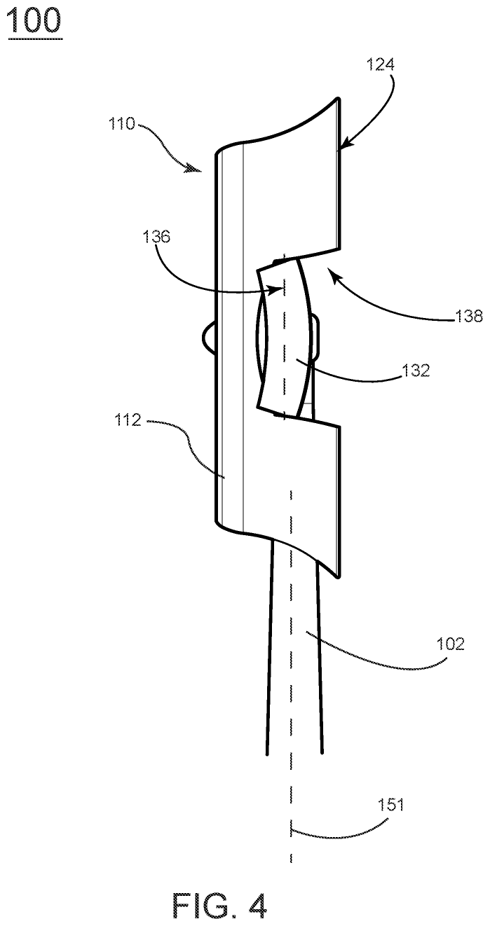

FIG. 4 shows the opening 138 and illustrates the reduction in sidewall surface area as a result of the example configuration. Wind force on the turbine's sidewall causes mechanical stress to the turbine and specifically, moment-arm forces on the tower 102. The opening 138 reduces acrodynamic drag, relieving pressure on the surface and moment-arm forces on the tower 102 in high winds.

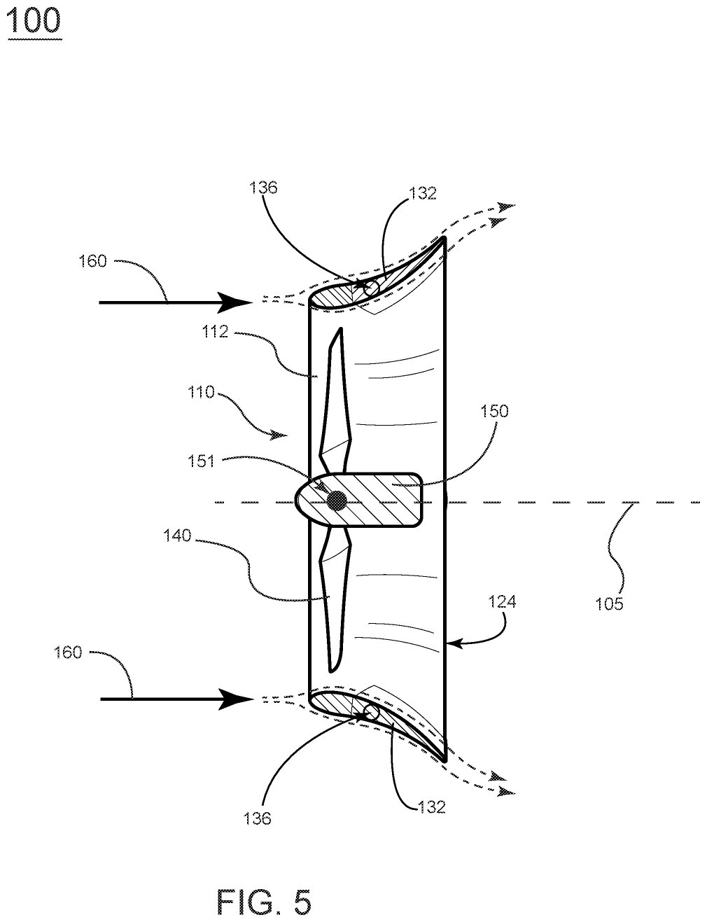

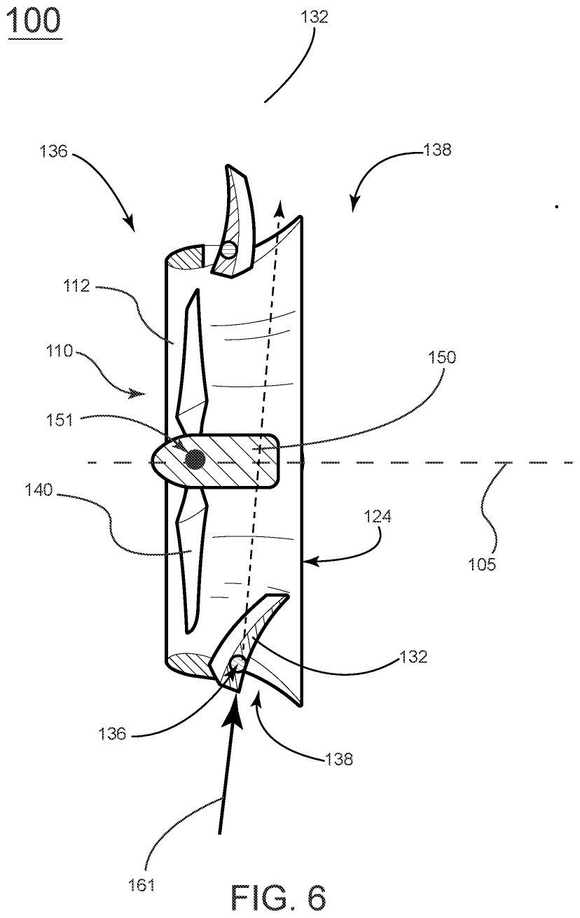

A turbine shroud has the cross-sectional shape of an airfoil with the suction side (low-pressure side) on the interior of the shroud. FIG. 5 and FIG. 6 show a top, cross-section view of the turbine with apportioned segments in the closed position (FIG. 5) and in the open position (FIG. 6). Wind flowing in a direction shown by arrow 160, flowing approximately along the direction of the central axis 105, keeps the apportioned segment 132 aligned with the cross-sectional shape of the shroud. As the turbine is rotated or as wind flows in a direction indicated by arrow 161 (approximately perpendicular to the central axis 105), the apportioned segments 132 rotate on pivot axis 136 to an open position (FIG. 6).

One skilled in the art understands that apportioned segments may be rotated inward or outward for the purpose of reducing side surface area to reduce moment-arm forces on the tower 102. Apportioned segments may pivot on an up-wind edge, a down-wind edge or about any point between.

Apportioned segments may be held in place and pivoted, as described, by the direction of the fluid stream. One skilled in the art understands that articulation of the apportioned segments may, alternatively, be mechanically controlled. During normal operation, such apportioned segments may be held in in place under tension by a torsion spring and maintained in place by an interference mechanism such as a pin. In such a configuration, apportioned segments may be rapidly deployed by removing the interference mechanism to release the tension; for example by removing the pin to release the torsion spring. Other example embodiments may include a mechanical or pneumatic actuation of the apportioned segments that are not under tension during normal operation of the turbine.

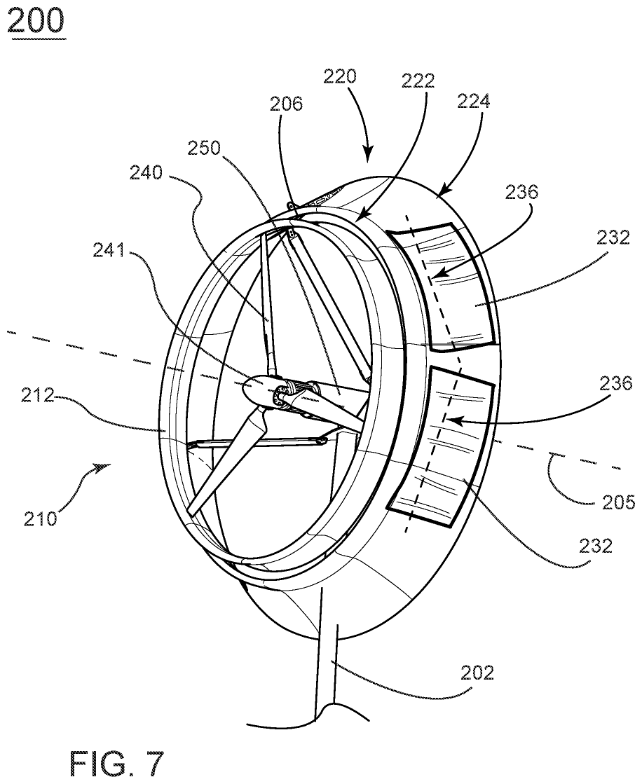

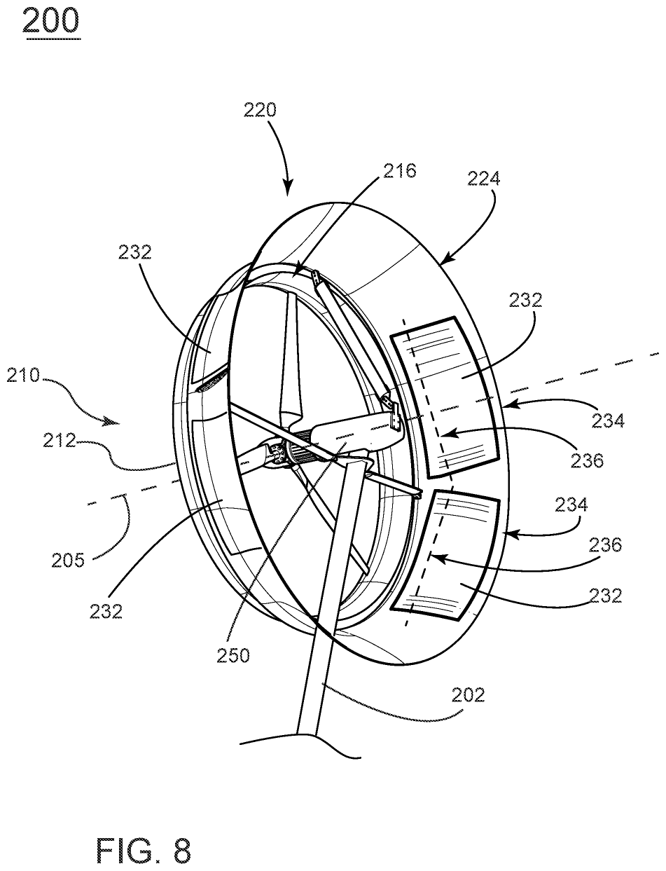

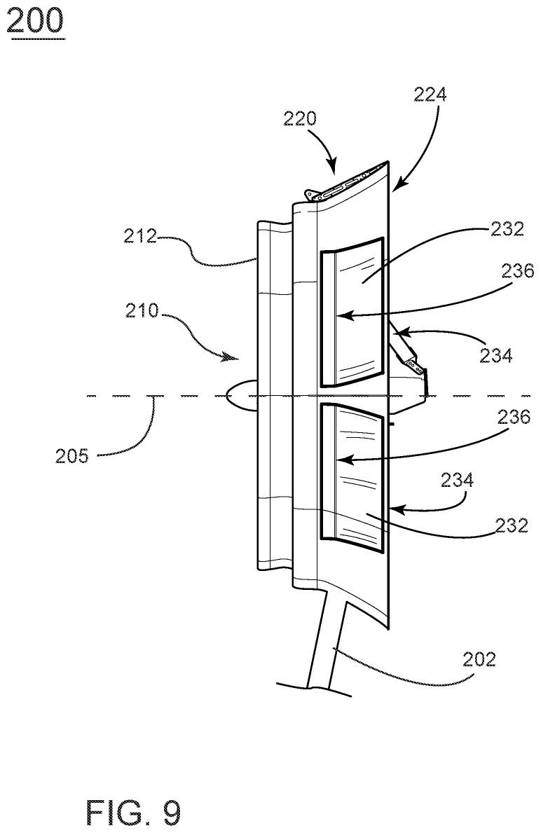

FIG. 7 and FIG. 8 show an additional embodiment of a shrouded fluid turbine. FIG. 9 is a side orthographic view of the shrouded fluid turbine of FIG. 7. In FIG. 7, FIG. 8 and FIG. 9, the shrouded fluid turbine 200 comprises a turbine shroud 210, a nacelle body 250, a rotor 240, and an ejector shroud 220. The turbine shroud 210 includes a front or inlet end 212 (also referred to as a leading edge). The turbine shroud 210 has a rear or exhaust end 216, (also referred to as a trailing edge). Similarly, the ejector shroud 220 includes a front end, inlet end/leading edge 222, and an exhaust end/trailing edge 224. An apportioned segment 232 is derived from a portion of one of the ringed airfoils 210/220 articulates on a pivot axis 236.

The rotor 240 surrounds the nacelle body 250 and comprises a central hub 241 at the proximal end of the rotor blades. The central hub 241 is rotationally engaged with the nacelle body 250. The nacelle body 250 and the turbine shroud 210 are supported by a tower 202. The rotor 240, turbine shroud 210, and ejector shroud 220 share a common central axis 205. A generator is disposed within the nacelle 250 and is engaged with the rotor by an energy-transfer means such as a direct drive, a belt drive or through a transmission.

The turbine shroud has the cross-sectional shape of an airfoil with the suction side (low-pressure side) on its interior. Articulation of the aforementioned apportioned segment 232 may be active, passive or some combination thereof. The apportioned segment may be actuated by user input, and may be based on data gathered from one or more suitable sensors deployed within the turbine assembly.

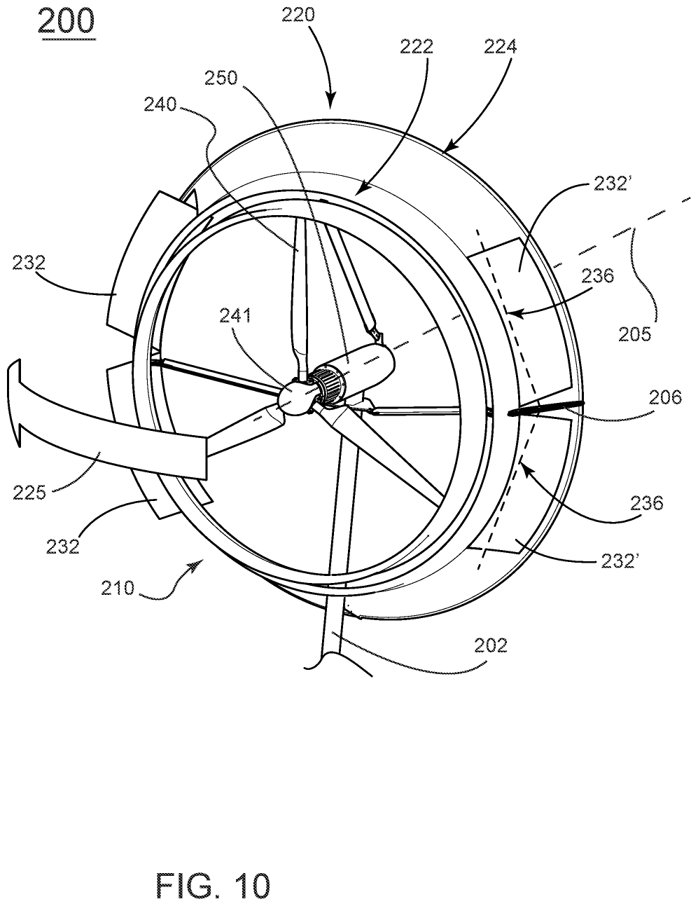

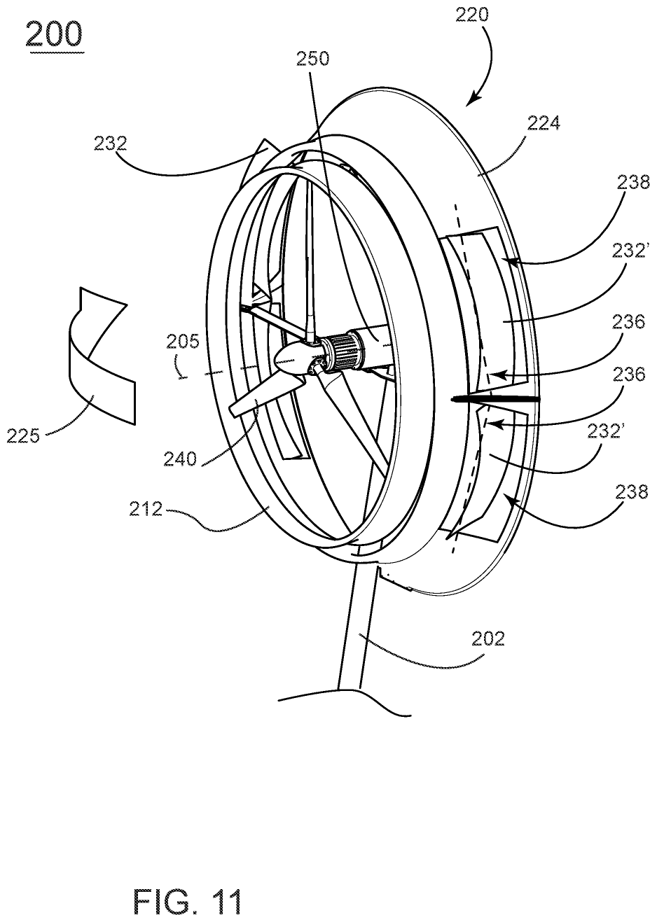

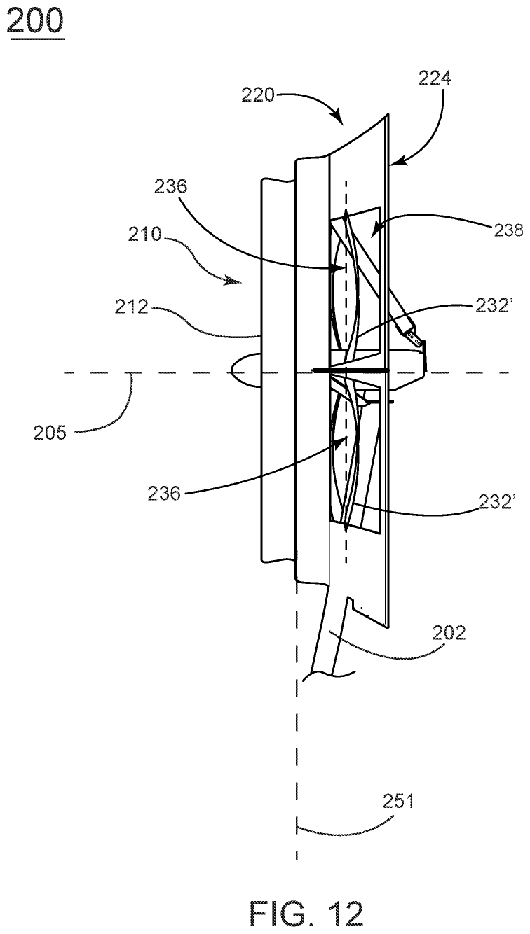

In FIG. 10, FIG. 11 and FIG. 12, like reference numbers refer to like components. Apportioned segment 232 is a segment of the airfoil comprising an ejector shroud 220 and a pivot axis 236 that is mated to the remaining portion of the airfoil. Although it is not essential, a section of the leading edge 222 is depicted as remaining fixed in relation to the apportioned segment 232. “Pivoting” and “pivot axis” terms are solely for clarity and ease of describing the invention and are not intended to be limiting in scope.

This example embodiment has apportioned segments 232 residing on a first side of the turbine and apportioned segments 232′ residing on the opposite side of the turbine. The apportioned segments 232 on the first side of the turbine 200 may be rotated mechanically outward, away from the central axis 205, while wind is flowing parallel to the central axis 205, causing the turbine to rotate in the direction of arrow 225. As the turbine rotates in direction 225, apportioned segments 232′ on the opposite side of the turbine 200 rotate inward, toward the central axis 205. One skilled in the art understands that passively actuated segments may also be mechanically actuated.

1. A fluid turbine, comprising:
a rotor mechanically coupled with a generator; and
at least a first duct in fluid communication with said rotor; and
said rotor and said at least a first duct sharing a common central axis; and
said at least a first duct having a top portion, bottom portion and a first sidewall portion, and a second sidewall portion extending between said top portion and said bottom portion; and
at least one sidewall portion apportioned to at least one segment; and
a means of articulating said apportioned at least one segment; wherein
said apportioned at least one segment is employed to alter the side surface area of said at least a first duct.

2. The fluid turbine of claim 1 wherein the apportioned at least one segment is moved by a fluid stream flowing in a direction that is out of alignment with said central axis.

3. The fluid turbine of claim 1, wherein the apportioned at least one segment is normally held in tension and is deployed when released from said tension.

4. The fluid turbine of claim 1, wherein the apportioned at least one segment is normally at rest and movement of said apportioned at least one segment is mechanically actuated.

5. The fluid turbine of claim 1, wherein the first duct has an airfoil cross section.

6. The fluid turbine of claim 1 further comprising a second duct; wherein
the leading edge of the second duct is in fluid communication with the trailing edge of said first duct; and
said second duct having a top portion, bottom portion and a first sidewall portion extending between said top portion and said bottom portion, and a second sidewall portion extending between said top portion and said bottom portion.

7. The fluid turbine of claim 6 wherein said second duct comprises one or more apportioned segments on said first sidewall portion and said second sidewall portion.

8. The fluid turbine of claim 7 wherein at least a second duct comprises one or more apportioned segments engaged with a control means.

9. A fluid turbine, comprising:
a rotor in communication with a generator; and
a ringed airfoil in fluid communication with said rotor; and
said ringed airfoil and rotor sharing a common axis; and
said ringed airfoil apportioned to at least one segment; and
said apportioned at least one segment pivotable about an axis; and
aerodynamic lift over said ringed airfoil, when wind flows along the turbine central axis, providing sufficient force to hold said apportioned at least one segment in a stowed position; and
wind flowing perpendicular to the turbine central axis, eliminating said lift force, providing sufficient force to open said apportioned at least one segment; wherein said pivotable apportioned at least one segment is employed to alter the side surface area of the ringed airfoil to reduce drag in high fluid velocity conditions.
